(19) United States
(12) Patent Application Publication
(10) Pub. No.: US 2011/0061481 A1
(43) Pub. Date: Mar. 17, 2011

(54) POSITIONING DEVICE FOR POSITIONING A LOAD

(76) Inventor: Jurgen Zimmermann, Bregenz (AT)

(21) Appl. No.: 12/559,877

(22) Filed: Sep. 15, 2009

(30) Foreign Application Priority Data
Sep. 11, 2009 (AT) A1435/2009

(51) Int. Cl. F16H 25/20

(52) U.S. Cl. 74/89.23

(57) ABSTRACT

A positioning device (1) for positioning a load (2) having at least one shaft (4) extending longitudinally in the axial direction (3) and at least one nut (5) engaging the shaft (4) and having at least one housing (6), with an axial bearing (7) being arranged in said housing (6) and the shaft (4) and/or the nut (5) being supported in the axial direction (3) at the axial bearing (7), with the axial bearing (7) being fastened at the housing (6) via at least one fastening bolt (8), with the fastening bolt (8) being guided through a recess (9) in the housing wall (10) of the housing (6) and fastened at the axial bearing (7).

### BACKGROUND

The present invention relates to a positioning device for positioning a load having at least one spindle extending longitudinally in an axial direction and at least one nut engaging said spindle and at least one housing, with an axial bearing being arranged in the housing, and with the spindle and/or the nut being supported in the axial direction on the axial bearing.

Such positioning devices are known in prior art in a multitude of embodiments. Among other things, they are used to adjust and/or position solar collectors, antennas, particularly parabolic antennas, but also for many other applications, in which loads must be positioned and/or adjusted in their position. An essential feature of generic positioning devices is the cooperation of the spindle and the nut engaging each other. Embodiments are known, in which a spindle is pivoted in reference to the housing. Other embodiments provide for the nut to be pivoted in reference to the housing. Additionally, there are embodiments, in which the spindle is displaced in the axial direction in reference to the housing. Other embodiments provide in turn that the nut is displaced in the axial direction in reference to the housing. A generic positioning device is shown, e.g., in DE 20 2005 003 981 U1. Here, a frontal lid of the housing forms the axial support for the nut and thus indirectly for the spindle as well. Another generic embodiment is known from EP 2 025 852 A1. Here, the threaded spindle is supported in the axial direction inside the housing via two roller bearings, arranged at a distance from each other.

Another generic positioning device is known from EP 1 741 664 B1. In this publication the axial support of the nut and the spindle occurs via ball bearings directly at a part of the housing base.

### SUMMARY

The object of the present invention is to provide an alternative generic positioning device allowing an axial support of the spindle and/or the nut inside the housing of the positioning device that is easily assembled, holds securely, and shows a simple design.

This is attained according to the invention in the axial bearing being mounted to the housing via at least one fastening bolt, with the fastening bolt being guided through a recess in a housing wall of the housing and fastened at the axial bearing.

Through the use of the fastening bolt or the fastening bolts, the axial bearing can be fastened at the housing of the positioning device in a simple fashion according to the invention. It is sufficient to guide the fastening bolt through the recess in the housing wall and to fasten it at the axial bearing. In spite of this structurally simple and easily assembled construction, this allows a secure fastening of the axial bearing inside the housing and thus a secure and stable support of the spindle and/or the nut in the axial direction, particularly at the housing. In preferred embodiments the recess in the housing wall may have a circular cross-section. However, different cross-sectional embodiments of this recess are also possible. An axial bearing generally represents a body supporting a spindle and/or a nut. In this sense, it may also be called an axial bearing body or an axial bearing flange. Generally, either the nut or the spindle is supported directly and the respectively other one of the two parts indirectly. The fastening of the fastening bolt at the axial bearing may be embodied in different fashions. A preferred variant provides for the fastening bolt to be fastened in a recess of the axial bearing, preferably a blind hole. The recess and/or the blind hole in the axial bearing is preferably located in an axial bearing housing and/or in its exterior surface pointing towards the housing wall.

Preferred embodiments provide that the spindle or the nut are supported in the axial direction at the axial bearing, rotational via at least one rotary bearing, preferably a ball bearing or a friction bearing. In turn, in order to support this rotary bearing at the axial bearing, preferred embodiments provide for the axial bearing to comprise an axial bearing housing, with the rotary bearing preferably in its entirety being arranged inside the axial bearing housing. This way, the rotary bearing may also be considered a part of the axial bearing assembled of several parts. Embodiments according to the invention can be assembled particularly easily when the axial bearing comprises at least two axial bearing housing parts that are or can be connected to each other, with the rotary bearing being arranged between the axial bearing housing parts. By adjusting the distance and/or the relative position of the axial bearing housing parts in reference to each other a rotary bearing and/or ball bearing arranged between them and/or its respective play can also be adjusted.

A variant of attaching a fastening bolt to the axial bearing can be realized, in a manner particularly easy to assembly yet in spite thereof durable and stable, by attaching the fastening bolt in the axial bearing, preferably exclusively by way of friction-fitting, preferably via force-fitting. This can be realized in a particularly simple fashion when the axial bearing comprises a recess, preferably a hole or a blind hole to attach the fastening bolt therein via friction-fitting. The friction fitting may also be achieved via force-fitting. Force-fitting develops when the recess in the axial bearing is slightly smaller than the exterior diameter of the fastening bolt contacting it. In this case, the elastic return forces of the fastening bolt pressed into the recess of the axial bearing ensure the force-fitting and/or the friction-fitting. In the same manner, the fastening bolt may also be fastened in the housing wall and/or in the recess in the housing wall which it is guided through. Here, too it is therefore possible to attach the fastening bolt via friction-fitting, preferably via force-fitting in the housing wall. In force-fitting and/or friction-fitting the exterior wall of the fastening bolt and the interior wall of the recess of the axial bearing and/or the interior wall of the recess in the housing wall, into which the fastening bolt is inserted and/or through which it is guided, may be embodied smoothly and/or continuously, preferably over the entire range of the respective force-fitting. In these embodiments it is generally achieved that the axial bearing is fastened at the housing via the fastening bolt, torque-proof in reference to the housing. Thus, in these variants the fastening bolt cannot be rotated in reference to the housing, which can also be achieved by other means than the above-mentioned friction-fitting and/or force-fitting, of course.

For reasons of a symmetrical transmission of force, preferred embodiments of the invention provide that the axial bearing is mounted at the housing via at least two fastening bolts, preferably arranged at opposite sides of the housing.

In the sense of an embodiment of the positioning device according to the invention as simple and compact as possible, it is provided in particularly preferred embodiments that the fastening bolt is a part of a swivel bearing, at which the housing is or can be pivotally supported. Therefore, in these embodiments the fastening bolt serves two functions. On the one hand, it fastens the axial bearing at the housing of the positioning device. On the other hand, it also forms a part of a swivel bearing, at which the housing is or can be pivotally supported. In order to avoid having to embody the fastening bolt or the housing wall of the housing in a particularly massive fashion, preferred embodiments provide for the fastening bolt to comprise a hole or a blind hole, in which an axial bolt of the swivel bearing is or can be supported, preferably in a rotational fashion.

The figures show embodiments of a positioning device according to the invention. In the following, additional features and details of the preferred variants shown are explained.

### BRIEF DESCRIPTION OF THE DRAWINGS

The figures show:

FIG. 1 a partially cross-sectioned side view of a first exemplary embodiment of a positioning device according to the invention;

FIG. 2 a cross-section taken along the line AA of FIG. 1;

FIG. 3 a cross-section taken along the line BB of FIG. 1;

FIG. 4 a section C of FIG. 2;

FIG. 5 a cross-sectional illustration of a fastening bolt of the first exemplary embodiment;

FIG. 6 a perspective illustration of a fastening bolt;

FIG. 7 a perspective illustration of a first axial bearing housing part of the positioning device of the first exemplary embodiment;

FIG. 8 a perspective illustration of a second axial bearing housing part of the positioning device of the first exemplary embodiment;

FIG. 9 a partially cross-sectional side view of the axial bearing housing part of FIG. 7;

FIGS. 10 and 11 an example showing the use of a positioning device according to the invention;

FIG. 12 a schematic illustration of a second exemplary embodiment according to the invention.

### DETAILED DESCRIPTION OF THE PREFERRED EMBODIMENTS

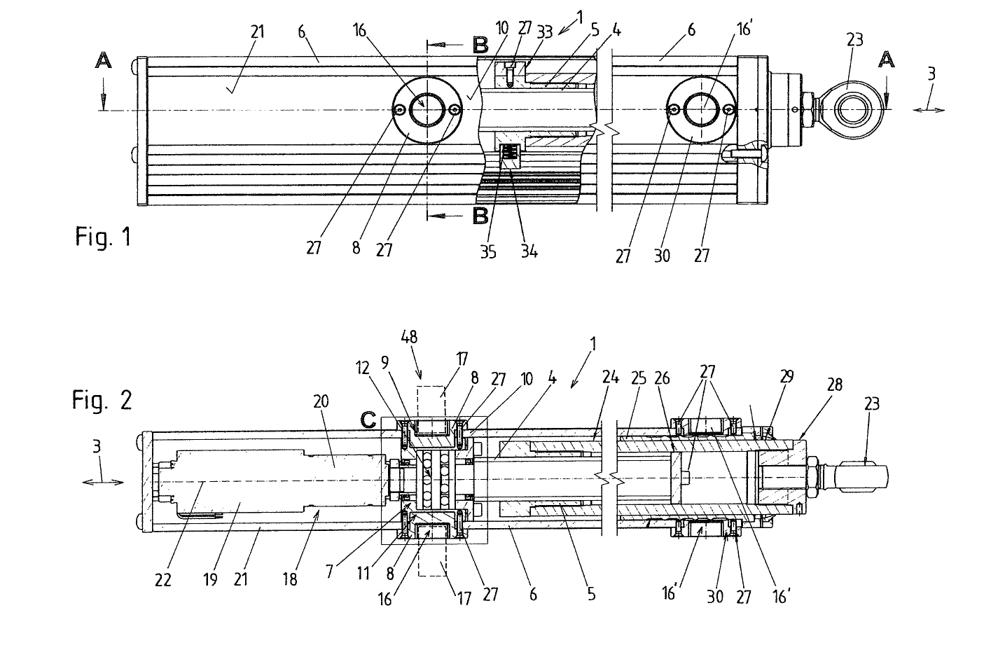

FIG. 1 shows a positioning device 1 of the first exemplary embodiment according to the invention in a side view. A nut 5 as well as a spindle 4 are arranged in a housing 6, as explained in detail in the following using the figures below. The housing 6 comprises a housing wall 10 which forms the exterior wall of the housing 6. In the exemplary embodiment shown, two recesses 9 are provided in this housing wall 10, opposite each other, through which the fastening bolts 8 are guided in order to be fastened at the axial bearing 7 in the interior of the housing 6, as explained in greater detail in the following. In FIG. 1, the housing 6 is shown shortened in the sense of a compact illustration. An area with a cross-sectional illustration is here located in the center. This illustration shows how in the interior of the housing 6 the spindle 4 is guided through the nut 5 and engages it and/or is in an operative connection therewith. For this purpose, in the exemplary embodiment shown the spindle 4 comprises an exterior thread here, not shown in this drawing, which engages a corresponding interior thread of the nut 5, not shown in this drawing, either. In prior art various forms of threads are known for such an arrangement of a nut and a spindle. In general, all forms known from prior art may be used, here.

In the first exemplary embodiment, the spindle 4 is supported in the axial direction 3 at the housing 6 via the axial bearing 7, thus it cannot be displaced in the direction of its longitudinal extension. However, the nut 5 is connected in a torque-proof manner to the push rod and/or the push tube 24 and together therewith it can be moved in the two axial directions 3. Further, the connection between the nut 5 and the push rod and/or the push tube 24 is embodied such that no relative motion is permitted between the nut 5 and the push rod 24 in the axial direction 3. In general, here the term axial direction 3, used several times, comprises opposite directions parallel in reference to the longitudinal extension of the spindle 4, as also shown in FIGS. 1 and 2 by the double arrow 3.

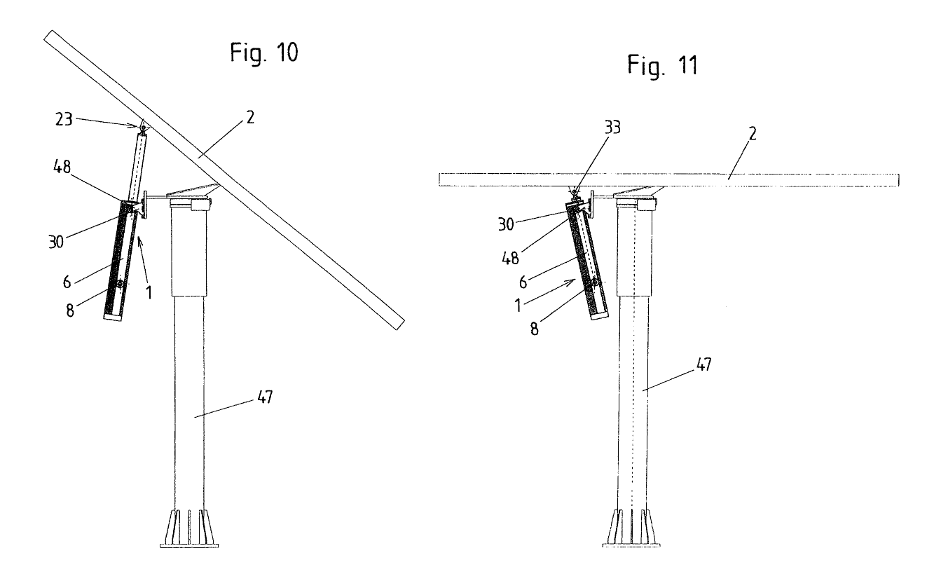

A fastening flange 23 is arranged at the push rod and/or the push tube 24 at the end facing away from the housing 6, provided to fasten the push rod 24 at a load 2 to be positioned or at a respective counter bearing, such as the pole 47 shown in FIGS. 10 and 11. Beneficially, the fastening flange 23 is embodied here such that the push rod and/or the push tube 24 can perform a swiveling motion in reference to the object at which the fastening flange 23 is mounted. In general, within the scope of the invention, the end of the push rod and/or the push tube 24 facing away from the housing 6 may also show other forms suitable for its respective purpose. This also applies to the fastening flange, of course.

In order to position the load, the spindle 4 is rotated via a motor 19, shown in FIG. 2 and known per se, if applicable by interposing a transmission 20, also schematically shown in FIG. 2. Using this rotating motion and the threaded engagement of the spindle 4 in the nut 5, the nut 5 is adjusted and/or displaced in an axial direction 3 in reference to the housing 6, together with the push rod and/or the push tube 24 and the fastening flange 23, depending on the rotary direction of the spindle 4. FIGS. 1 and 2 show the status, in which the push rod 24 and the nut 5 are inserted almost in their entirety.

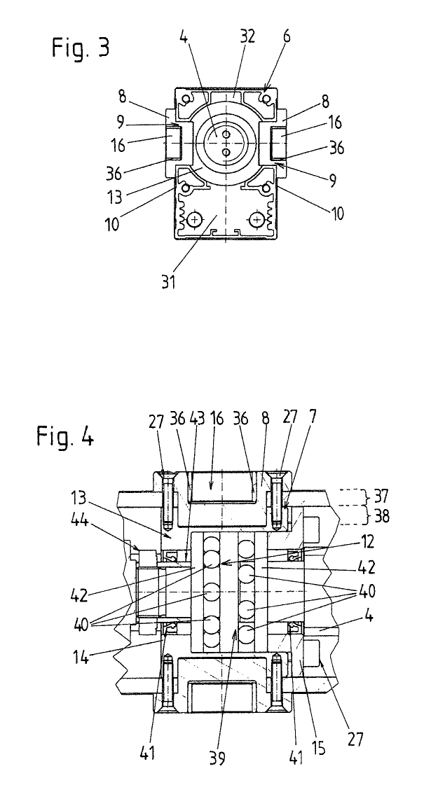

In order to prevent the nut from rotating simultaneously when the spindle 4 is rotated, a locking device 33 is fastened at the nut 5, in the exemplary embodiment shown using the screw 27. The pin forming the locking device 33 is guided in the guiding groove 32 in the axial direction 3 in a longitudinally displaceable fashion, as discernible in the cross-section BB in FIG. 3. The locking device 33 prevents the rotation of the nut 5 around the axial direction 5 in the housing 6. At the side opposite the locking device 33, in the exemplary embodiment shown an actuating cam 34 is arranged at the nut 5 for operating the end switches and the like. The actuating cam 34 is mandatorily coupled thereto in the axial directions 3 with regard to displacing the nut 5 and serves to operate the end switches, known per se but not shown here, arranged in the receiving space 31 shown in FIG. 3. In the exemplary embodiment shown, the actuating cam 34 is pre-stressed against the nut in the radial direction via a spring 35. For the sake of completeness, it is pointed out here that the arrangement of the locking device 33 and the actuating cam 34 may also be embodied differently.

As particularly discernible from FIG. 3, in the exemplary embodiment shown, the housing 6 represents a hollow profile, which encloses with its housing wall 10 a hollow space in which the axial bearing 7, the spindle 4, and preferably all other components of the positioning device 1 according to the invention are arranged. In order to guide the fastening bolt 8 through said housing wall 10, recesses 9 are provided therein. In the exemplary embodiment shown these recesses 9 are embodied circularly in their cross-section, as is the respective section of the fastening bolt 8, which is guided through the recess 9. Of course, other cross-sectional shapes are possible, as well.

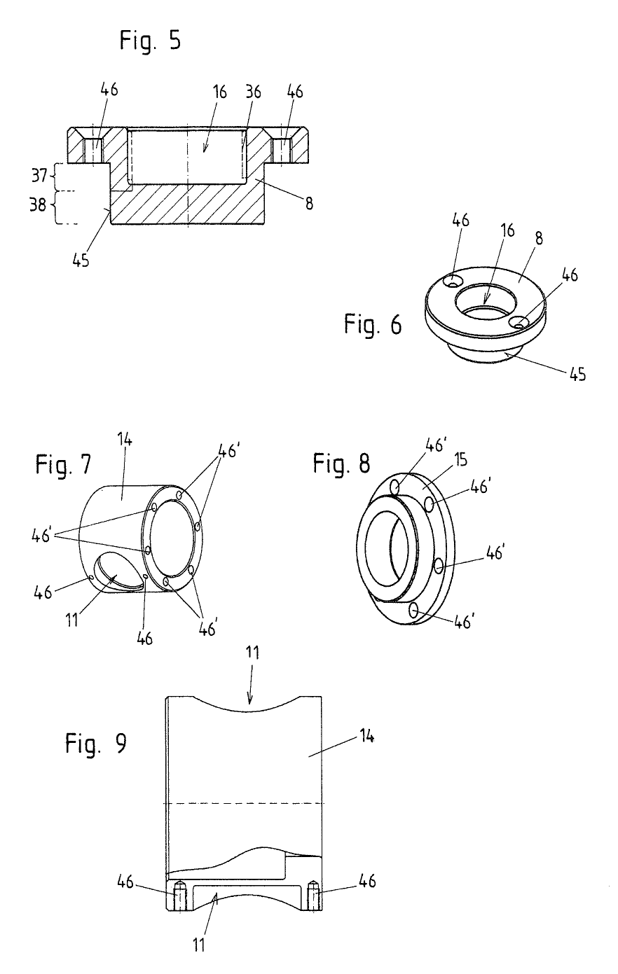

In the exemplary embodiment shown the fastening bolt 8 fulfills a dual function. On the one hand, according to the invention it serves to fasten the axial bearing 7 at the housing 6. Furthermore, in the exemplary embodiment shown it also forms a part of the pivot support 48, at which the housing 6 can be supported in a pivotal fashion. For this purpose, in the exemplary embodiment shown the fastening bolt 8 comprises a blind hole 16, in which an axial bolt 17 of the pivot support 48 is or can be supported as indicated by dot-dash lines in FIG. 2. Beneficially, the swiveling motion occurs between the axial bolt 17 and the fastening bolt 8 and/or its blind hole 16, when the positioning device 1 and/or the housing 6 is rotated. In other words, beneficially the axial bolt 17 is supported rotationally in a blind hole 16. In order to reduce friction between the axial bolt 17 and the fastening bolt 8 during swiveling a bearing ring 36 made from a low-friction material may be arranged in the blind hole 16, as indicated in FIG. 5. However, embodiments are also possible, in which the additional bearing ring 36 is waived, which may be pressed into the blind hole 16, for example. For the sake of completeness, it is pointed out that in a different embodiment of the invention it may also be provided for the axial bolt 17 to be connected to the fastening bolt 8 in a fixed and/or torque-proof manner. Then, the arrangement comprising an axial bolt 17 and a fastening bolt 8 can also be supported in another part of the pivot support 48, for example rotationally.

As an alternative pivot point for a pivot support 48, in the first exemplary embodiment of the positioning device 1 an additional and/or alternative bearing point is provided in the form of the additional swivel bearing eye 30. In the exemplary embodiment shown, this additional swivel bearing eye is fastened in the housing wall 10 in the same manner as the fastening bolt 8, as explained in greater detail in the following. In order to allow the receiving of an axial bolt 17, the additional swivel bearing eye 30 also comprises a blind hole 16′. Here, a friction reducing bearing ring can also be arranged and/or impressed therein. The various variants of the swivel bearing already described with regard to the fastening bolt 8 can also be implemented in the additional swivel bearing eye 30.

FIG. 2 shows a longitudinal cross-section AA through the positioning device 1 of the first exemplary embodiment. Section C of FIG. 2 shows the fastening of the axial bearing 7, essential for the invention, using in the exemplary embodiment two fastening bolts 8 at the housing 6 and/or the housing wall 10. Section C is enlarged in FIG. 4 and is explained in greater detail in the following, using said figure.

Furthermore, it is particularly discernible from FIG. 2 that the housing 6 comprises an receiving chamber 18 for a motor 19 and/or a transmission 20, with the receiving chamber 18 being at least partially surrounded, here completely surrounded, by a receiving chamber wall 21. Further, the receiving chamber wall 21 of this exemplary embodiment is embodied in one piece with the remaining housing wall 10. In other words, the receiving chamber wall 21 forms a part of the housing wall 10. Here it is beneficial, as explained in the exemplary embodiment, when seen from the outside and in the axial direction, the receiving chamber wall 21 gradually merges with the remaining housing wall 10. On the one hand, this leads to an optically pleasant design. On the other hand, a compact design of the positioning device 1 is achieved thereby. The motor 19 and the transmission 20 are illustrated only very schematically in the exemplary embodiment shown in FIG. 2. Its embodiment is known in prior art so that details can be omitted, here. The transmission 20 is connected in a torque-proof fashion to the spindle 4 via the transmission flange 44 visible in FIG. 4 such that by rotating a motor shaft 22, only shown schematically, the spindle 4 can also be rotated via the motor 19. In the sense of a compact design as realized in the exemplary embodiment shown here, the motor shaft 22 is arranged coaxially in reference to the spindle 4. Of course, all other connections of a motor 19 to a spindle 4 known from prior art are also possible, e.g., via a worm gear or a belt drive or the like. If a transmission 20 is or is not required depends on the respective exemplary embodiment.

In the exemplary embodiment, the push rod and/or the push tube 24 exits the housing 6 at the end of the housing 6 opposite the receiving chamber 18. A doctor blade seal 29 prevents any contaminants from reaching the interior of the housing 6 when the push rod and/or the push tube 24 is reinserted. The head 28 of the push rod is located at the end of the push rod and/or the push tube 24 towards the front and serves as the connection for a fastening strap 23. The guidance and support of the push rod 24 and/or the push tube, displaceable in the axial direction, occurs at this end of the housing 6 via a slide bearing 25, beneficially in form of a cylinder and/or adjusted to the exterior shape of the push rod 24. Alternatively, other bearings are also possible, of course. The slide bearing 25 may represent a plastic or metallic body, for example, showing friction-reducing characteristics.

A locking device 26 is arranged at the end of the spindle 4 facing away from the axial bearing 7. The fastening at the spindle 4 occurs via a screw 27. The locking device 26 forms a stopping body, which stops the nut and thus prevents the spindle 4 from any further turning out of the nut 5 when the motor 20 has not been shut off earlier due to malfunction, e.g., via a shut-off switch known per se but not shown, here.

The two additionally provided swivel bearing eyes 30, arranged opposite each other, have already been mentioned. In the first exemplary embodiment they are anchored via force-fitting in a corresponding recess in the housing 6 and/or its housing wall 10. Additionally, as shown here, screw connectors 27 may also be provided in order to fasten the swivel bearing eye 30 in the housing wall 10.

Now, in FIG. 4 the section C of FIG. 2 is shown enlarged. It is discernible how the two fastening bolts 8 arranged opposite each other are guided via corresponding recesses 9 through the housing wall 10 in order to be fastened at the axial bearing 7, thus fixing the axial bearing 7 in the housing 6. The fastening of the fastening bolt 8 in the axial bearing 7 occurs in recesses 11 of the axial bearing 7, which are particularly well discernible in FIGS. 7 and 9. As implemented in this exemplary embodiment, the fastening bolt 8 is beneficially anchored both in the housing wall 10 as well as in the axial bearing 7 by way of friction-fitting and/or force-fitting. A first force-fitting connection is located in the area 37, by which the fastening bolt 8 is held in the housing wall 10. 38 marks the area of the second force-fitting connection. In this area, the fastening bolt 8 is fastened in the axial bearing 7 by way of force-fitting. Additionally, in this exemplary embodiment, two screws 27 each are provided, which provide an additional connection for the fastening bolt at the housing and/or the housing wall 10 and at the axial bearing 7. These additional screw connections may be omitted due to the force-fitting, so that then the fastening of the fastening bolt 8 occurs exclusively via friction-fitting and/or force-fitting in the housing wall 10 and/or in the axial bearing 7.

In the exemplary embodiment shown, the axial bearing 7 comprises an axial bearing housing 13. Recesses 11 are arranged in the axial bearing housing 13, on the one hand, in which the fastening bolt 8 is fixed by way of force-fitting. On the other hand, the axial bearing housing 13 according to the first exemplary embodiment comprises a central channel, penetrating in the axial direction 3, through which the spindle 4 is guided. A rotary bearing 12 is provided inside the axial bearing housing 13, which serves for a rotational support of the spindle 4 at the axial bearing 7 and/or its axial bearing housing 13. In the exemplary embodiment shown the rotary bearing 12 represents a ball bearing. The central ring 39 is connected to the spindle 4 in a torque-proof fashion, and also fixed in the axial direction 3. This ring and thus also the spindle 4 are supported in the axial directions 3 via the balls 40 on the two outer rings 42. The spindle 4 and the central ring 39 can rotate in reference to the two outer rings 42. The outer rings 42 in turn are supported in the axial directions 3 at the axial bearing housing 13. The axial bearing housing 13 is embodied in two parts, in the exemplary embodiment shown. The two axial bearing housing parts 14 and 15 are shown individually in FIGS. 7 and 8. They are connected to each other via screws 27. The two-part design of the axial bearing housing 13 allows, on the one hand, a simple assembly of the rotary bearing 12. On the other hand, the play of the rotary bearing 12 and/or the ball bearing can be adjusted by adjusting the distance and/or the relative position of the two axial bearing housing parts 14 and 15 in reference to each other. In the exemplary embodiment shown, a spacer socket 43 is arranged between the above-mentioned transmission flange 44 for a torque-proof connection of the spindle 4 to the engine 19 and/or its transmission 20 and the closest outer ring 42. The inner chamber of the axial bearing housing 13 is sealed from the outside by the gaskets 41, primarily in order to prevent any contaminants from entering. For the sake of completeness it is pointed out, here, that in axial bearing housings 13 embodied in two parts the connection between the axial bearing housing parts 14, 15 can also be realized in a different fashion, of course. For example, it is also possible to provide an internal thread at the axial bearing housing part 14, into which an external thread of the axial bearing housing part 15 can be screwed.

FIG. 5 shows a cross-section through the fastening bolt 8. The areas of the fast and second force-fitting 37 and 38 at the shell 45 of the fastening bolt 8 are sketched in once more, similar to the screw holes 46 and the optional friction-reducing bearing ring 36. FIG. 6 shows a perspective illustration of the fastening bolt 8 embodied in this way. FIGS. 7 and 8 show the two axial bearing housing parts 14 and 15 in a position separated from each other. Here, the screw holes 45′ are discernible for connecting the two axial bearing housing parts 14 and 15. Here, the recess 11 in the axial bearing 7 and/or its housing 13 is particularly well discernible, in which the area 38 of the shell 45 of the fastening bolt 8 can be anchored via force-fitting. The second axial bearing housing part 15 is shown slightly enlarged in FIG. 8. In reality, the two axial bearing housing parts 14 and 15 are sized such that they fit into each other as shown in FIG. 4.

FIGS. 10 and 11 show one of many potential applications and/or uses of a positioning device 1 according to the invention. In the exemplary embodiment shown it serves to swivel the load 2 embodied in the form of a solar module. In the exemplary embodiment shown, this load 2 is pivotally linked to the pole 47. The housing 6 is pivotally linked to the pole 47 via the pivot support 48. The fastening flange 23 of the positioning device 1 is pivotally linked to the load 2. In the exemplary embodiment shown the pivot support 48 of the housing 6 occurs at the additional swivel bearing eye 30. In another exemplary embodiment the fastening bolt 8 may also fulfill a dual function, by the pivot support 48 engaging here. In a manner similar to the one shown in FIGS. 10 and 11, other loads 2, such as antennas, parabolic antenna, or the like, may also be positioned as loads 2 to be adjusted by a positioning device 1 according to the invention.

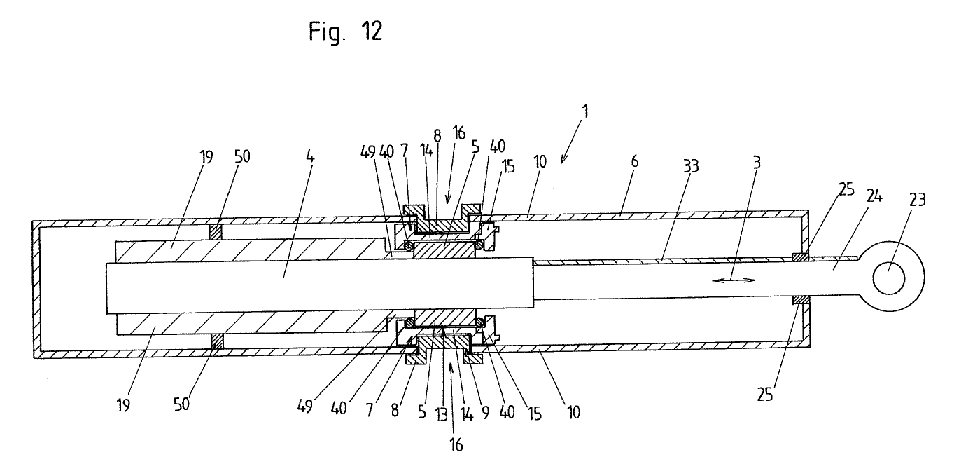

While in the first exemplary embodiment the positioning device 1 according to the invention, according to FIGS. 1 through 9, the spindle 4 is supported directly at the housing 6 and the nut 5 indirectly via the spindle in the axial direction using the axial bearing 7, in the second exemplary embodiment of the invention according to FIG. 12 the situation may be inversed. Here, the nut 5 is directly supported via the axial bearing 7 and the fastening bolt 8 in the axial direction 3 at the housing 6 and/or its housing wall 10. In the second exemplary embodiment, the nut 5 is thus held rotationally in and/or at the axial bearing 7, but is not displaceable in the axial direction 3. However, the spindle 4, engaging an internal thread of the nut 5 in a manner known per se via an external thread, can be displaced in the axial directions 3 together with the push rod 24. A locking device 33, in this exemplary embodiment embodied in the form of a comb, prevents any rotation of the spindle 4 and the push rod 24 around the axial direction 3 and/or in reference to the housing 6. Displaceable in the axial direction the locking device 33 is supported in a guiding groove, not shown in greater detail, in the cylindrical friction bearing 25.

In order to swivel the spindle 4, a motor shaft, not shown in detail here, of a motor 19, here embodied as a quill shaft motor and shown only schematically, is connected via a drive flange 49 to the rotationally supported nut 5. In order to fix the quill shaft motor 19, the fastening flanges 50 are provided, which connect the motor 19 to the housing 6. For a pivotal support of the nut 5 in the axial bearing 7 and/or its axial bearing housing 13 the balls 40 are provided, forming a rotational bearing and/or ball bearing. Except for the geometric adjustments necessary here the axial bearing 7 can be embodied identical to the first exemplary embodiment. This applies both for the fastenings according to the invention via the fastening bolts 8 to the housing 6 and/or the housing wall 10, as well as the two-part embodiment of the axial bearing housing 13. In general, it must be pointed out that the second exemplary embodiment, except for the differences shown, can otherwise be embodied identical to the first exemplary embodiment.

As already explained in detail in the first exemplary embodiment of a positioning device according to the invention, the spindle 4 is rotationally supported on the axial bearing 7 but it cannot be displaced in the axial direction 3. However, in the second exemplary embodiment according to FIG. 12, the nut 5 is rotationally supported at the housing 6 but via the axial bearing 7 but cannot be displaced in the axial direction 3. For the sake of completeness, here it is explicitly pointed out that the axial bearing according to the invention does not require for the part supported directly at the axial bearing 7 to be supported there in a pivotal manner. Rather, it is also possible to embody variants according to the invention with the spindle 4 or the nut 5 not being displaceable in the axial direction 3 and not being rotational, but being supported by a respective axial bearing 7 according to the invention in an entirely fixed fashion, due to one or more fastening bolts 8 at the housing 6.

Furthermore, it must be pointed out that the invention may serve not only for the support in the axial direction. Rather, in a preferred variant of the invention it may be provided, as also realized in the exemplary embodiments shown, that the spindle 4 and/or the nut 5 are supported at the axial bearing 7, and additionally in at least one radial direction orthogonally in reference to the axial direction 3, preferably orthogonally in reference to the axial direction 3 in all three radial directions

### LEGEND OF THE REFERENCE CHARACTERS

1 Positioning device
2 Load
3 Axial direction
4 Spindle
5 Mother
6 Housing
7 Axial bearing
8 Fastening bolt
9 Recess
10 Housing wall
11 Recess
12 Rotary bearing
13 Axial bearing housing
14 Axial bearing housing part
15 Axial bearing housing part
16, 16′ Blind hole
17 Axle bolt
18 Receiving chamber
19 Motor
20 Transmission
21 Receiving chamber wall
22 Motor shaft
23 Fastening flange
24 Push rod and/or push tube
25 Cylindrical slide bearing
26 Anti-rotation device
27 Screw
28 Head of the push rod
29 Doctor blade seal
30 Additional swivel bearing eye
31 End switch receiving chamber
32 Guiding groove
33 Locking device
34 Actuating cam
35 Spring
36 Bearing ring
37 Area with first force-fitting
38 Area with second force-fitting
39 Central ring
40 Balls
41 Seal
42 Outer ring
43 Spacer socket
44 Transmission flange
45 Shell of 8
46, 46′ Threaded holes
47 Pole
48 Pivot support
49 Drive flange
50 Fastening

1. A positioning device (1) for positioning a load (2) having at least one spindle (4) extending longitudinally in an axial direction (3) and at least one nut (5) engaging the spindle (4) and having at least one housing (6), with an axial bearing (7) being arranged in said housing (6) and with the spindle (4) or the nut (5) or the spindle (4) and the nut (5) being supported on the axial bearing (7) in the axial direction (3), wherein the axial bearing (7) is fastened at the housing (6) via at least one fastening bolt (8), and the fastening bolt (8) is guided through a recess (9) in a housing wall (10) of the housing (6) and fastened at the axial bearing (7).

2. A positioning device (1) according to claim 1, wherein the fastening bolt (8) is fastened in a recess (11) of the axial bearing (7).

3. A positioning device (1) according to claim 2, with the recess (11) is a blind hole (16).

4. A positioning device (1) according to claim 1, wherein the fastening bolt (8) is fastened in the axial bearing (7) by way of a friction-fit.

5. A positioning device (1) according to claim 1, wherein the fastening bolt (8) is fastened in the axial bearing (7) by way of a press-fit.

6. A positioning device (1) according to claim 1, wherein fastening bolt (8) is fastened in the housing wall (10) by way of a friction-fit.

7. A positioning device (1) according to claim 1, wherein the fastening bolt (8) is fastened in the housing wall (10) by way of a press-fit.

8. A positioning device (1) according to claim 1, wherein the axial bearing (7) is fastened to the housing (6) by at least two fastening bolts (8).

9. A positioning device (1) according to claim 8, wherein the fastening bolts (8) are arranged at opposite sides of the housing (6).

10. A positioning device (1) according to claim 1, wherein the spindle (4) or the nut (5) are supported in the axial direction (3) at the axial bearing (7) via at least one rotary bearing (12).

11. A positioning device (1) according to claim 10, wherein the rotary bearing (12) is a ball bearing or a slide bearing.

12. A positioning device (1) according to claim 10, wherein the axial bearing (7) comprises an axial bearing housing (13) with the rotary bearing (12) being arranged partially or entirely inside the axial bearing housing (13).

13. A positioning device (1) according to claim 10, wherein the axial bearing (7) comprises an axial bearing housing having at least two axial bearing housing parts (14, 15) that are or can be connected to each other, with the rotary bearing (12) being arranged between the axial bearing housing parts (14, 15).

14. A positioning device (1) according to claim 1, wherein the fastening bolt (8) is a part of a pivot support (48), at which the housing (6) is or can be supported in a pivotal manner.

15. A positioning device (1) according to claim 14, wherein the fastening bolt (8) comprises a hole or a blind hole (16), in which an axle bolt (17) of the pivot support (48) is or can be supported.

16. A positioning device (1) according to claim 15, wherein the axle bolt (17) of the pivot support (48) is or can be supported pivotally in the hole or blind hole (16).

17. A positioning device (1) according to claim 1, wherein the axial bearing (7) is connected to the housing (6) by the fastening bolt (8), torque-proof in reference to the housing (6).

18. A positioning device (1) according to claim 1, wherein the housing wall (10) of the housing (6), comprising the recess (9) through which the fastening bolt (8) is guided, represents an exterior wall of the housing (6).

19. A positioning device (1) according to claim 1, wherein the housing (6) comprises a receiving chamber (18) for a motor (19) or a transmission (20) or for a motor (19) and a transmission (20), with the receiving chamber (18) being at least partially surrounded by a receiving chamber wall (21) and the receiving chamber wall (21) being embodied in one pieces with the remaining housing wall (10).

20. A positioning device (1) according to claim 19, wherein the receiving chamber wall (21), seen from outside and in the axial direction (3), gradually merges with the remaining housing wall (10).

21. A positioning device (1) according to claim 1, wherein the housing (6) comprises a receiving chamber (18) for a motor (19) and the motor (19) comprises a rotational motor shaft (22), with the motor shaft (22) being arranged coaxially in reference to the spindle (4).
